(19) United States
(12) Patent Application Publication
(10) Pub. No.: US 2009/0184808 A1
(43) Pub. Date: Jul. 23, 2009

(54) METHOD FOR CONTROLLING VIBRATION MECHANISM OF A MOBILE COMMUNICATION TERMINAL

(75) Inventor: Beom-Soo KIM, Seoul (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LG ELECTRONICS INC.

(21) Appl. No.: 12/351,126

(22) Filed: Jan. 9, 2009

(30) Foreign Application Priority Data
Jan. 22, 2008 (KR) 10-2008-0006762

(51) Int. Cl. H04B 3/36

(52) U.S. Cl. 340/407.1

(57) ABSTRACT

A mobile terminal comprising: a controller for detecting an event occurring when the mobile terminal is manipulated and controlling vibration of the mobile terminal according to a pre-set method based on a type of the event; a memory for storing the preferred vibration method according to the type of event; and at least one vibration mechanism vibrating under the control of the controller, wherein the controller generates vibration if a parameter value related to the event exceeds a certain reference value mechanism

### CROSS-REFERENCE TO RELATED APPLICATIONS

Pursuant to 35 CFR 119, the present application claims priority to Korean Application No. 10-2008-0006762 filed in Korea on Jan. 22, 2008, the entire contents of which are hereby incorporated by reference in their entirety.

### TECHNICAL FIELD

The present disclosure relates to a method for outputting a sound effect with respect to a particular situation generated when a menu of a mobile terminal is manipulated or when a particular function is executed, and a mobile terminal implementing the same.

### BACKGROUND

A mobile terminal is a device which may be configured to perform various functions. Examples of such functions include data and voice communications, capturing images and video via a camera, recording audio, playing music files via a speaker system, and displaying images and video on a display.

Some terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components which form the mobile terminal. In terms of design, folder type, slide type, bar type, or rotation type design may be applied for mobile terminals.

Also, the mobile terminal outputs a sound effect for a particular situation when a menu is manipulated or when a particular function is executed. In this respect, however, when the surroundings are noisy, or for the hearing impaired, the sound effect is not properly heard, degrading the effect of generating the sound effect. A method and system that can provide a user with a means for outputting a vibration for a particular situation when a menu is manipulated or when a particular function is executed is needed.

### SUMMARY

To achieve these and other advantages and in accordance with the purpose of the present disclosure, as embodied and broadly described herein, the present disclosure provides in one aspect a mobile terminal comprising: a controller for detecting an event occurring when the mobile terminal is manipulated and controlling vibration of the mobile terminal according to a pre-set method based on a type of the event; a memory for storing the preferred vibration method according to the type of event; and at least one vibration mechanism vibrating under the control of the controller, wherein the controller generates vibration if a parameter value related to the event exceeds a certain reference value.

To achieve these and other advantages and in accordance with the purpose of the present disclosure, as embodied and broadly described herein, the present disclosure provides in another aspect a method for controlling a vibration mechanism of a mobile terminal, the method comprising: detecting a type of an event occurring when the terminal is manipulated, retrieving a vibration control method according to the type of the detected event if a parameter value related to the event exceeds a particular reference value; and driving a vibration mechanism at a particular position with a pre-set rhythm and strength according to the retrieved method. Further scope of applicability of the present disclosure will become apparent from the detailed description given hereinafter. However, it should be understood that the detailed description and specific examples, while indicating preferred embodiments of the disclosed mobile terminal and method, are given by illustration, since various changes and modifications within the spirit and scope of the invention will become apparent to those skilled in the art from this detailed description.

### BRIEF DESCRIPTION OF THE DRAWINGS

The present disclosure will become more fully understood from the detailed description given below and the accompanying drawings, which are given by illustration, and thus are not limitative of the present disclosure.

FIG. 1 is a schematic block diagram of a mobile terminal according to one embodiment;

FIG. 2 is a front perspective view of a mobile terminal according to one embodiment;

FIG. 3 is a rear perspective view of the mobile terminal in FIG. 2;

FIG. 4 is a block diagram of a wireless communication system with which the mobile terminal according to one embodiment is operable;

FIG. 5 is a flow chart illustrating the process of a method for controlling a vibration mechanism of the mobile terminal according to one embodiment;

FIGS. 6A to 6C are overviews of display screens illustrating menus for setting an environment to output a vibration sound effect of the mobile terminal according to one embodiment;

FIGS. 7A to 7E are overviews of display screens illustrating a method for outputting a vibration sound effect for each situation that may occur in the mobile terminal according to one embodiment;

FIG. 8 is a view for explaining a method for controlling a plurality of vibration mechanisms provided in the mobile terminal according to one embodiment; and

FIG. 9 is a graph for explaining a method for generating a movement effect when a vibration sound effect is outputted from the mobile terminal according to one embodiment.

Reference will now be made in detail to the preferred embodiments of the present disclosure, examples of which are illustrated in the accompanying drawings. If a detailed explanation for a related known function or construction is considered to unnecessarily divert the gist of the present disclosure, such explanation has been omitted but would be understood by those skilled in the art. In describing the present disclosure with reference to the accompanying drawings, like reference numerals are used for elements performing like functions.

### DETAILED DESCRIPTION OF EXAMPLE EMBODIMENTS

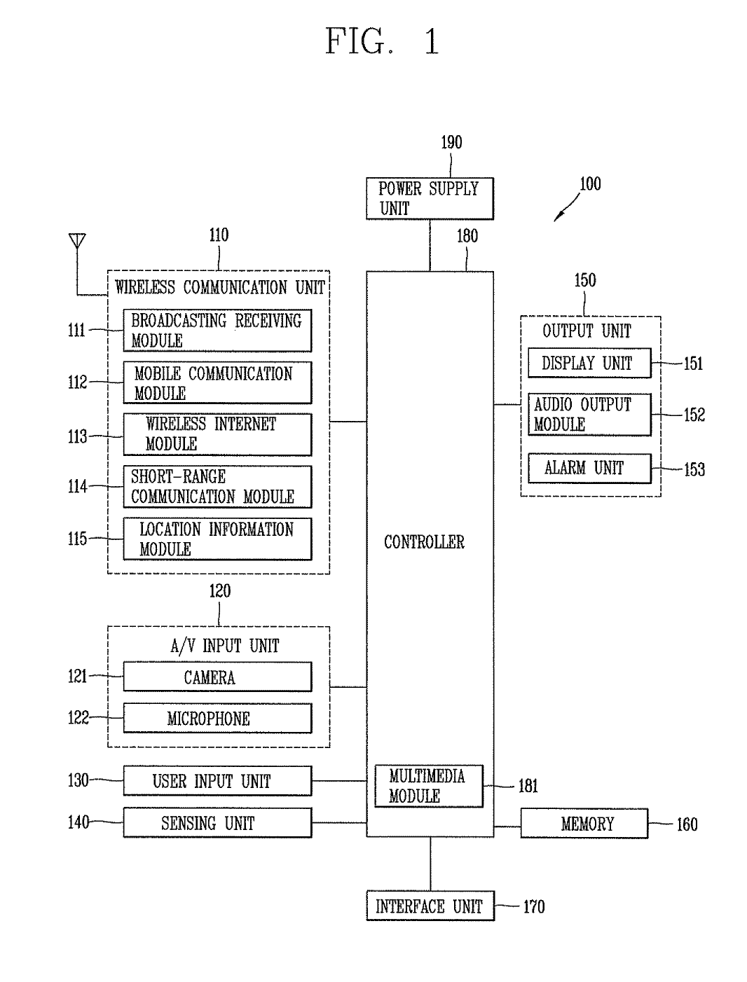

Referring to FIG. 1, a mobile terminal 100 according to one embodiment may be implemented in various configurations or form factors. Examples of such terminals include mobile phones, user equipment, smart phones, computers, digital broadcast terminals, personal digital assistants, portable multimedia players (PMP) or navigation devices.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. Greater or fewer components may alternatively be implemented. For example, the wireless communication unit 110 typically includes one or more components allowing radio communication between the mobile terminal 100 and a wireless communication system or a network in which the mobile terminal 100 is located.

The broadcast receiving module 111 receives broadcast signals and/or broadcast associated information from an external broadcast management server (or other network entity) via a broadcast channel. The broadcast channel may include a satellite channel and a terrestrial channel. The broadcast managing server may refer to a system that generates and transmits a broadcast signal and/or broadcast associated information or a server that receives a previously generated broadcast signal and/or broadcast associated information and transmits the same to a terminal.

Examples of the broadcast associated information may include information regarding a broadcast channel, a broadcast program, a broadcast service provider, etc. The broadcast signal may include a TV broadcast signal, a radio broadcast signal, a data broadcast signal, and the like. Also, the broadcast signal may further include a broadcast signal combined with a TV or radio broadcast signal.

The broadcast associated information may be provided also via a mobile communication network (e.g., that operates according to standards such as 3GPP, 3GPP2, IEEE, CDMA, GSM, OMA, or so-called 4G techniques, etc.) and, in this case, the broadcast associated information may be received by the mobile communication module 112.

The broadcast signal may exist in various forms. For example, it may exist in the form of an electronic program guide (EPG) of digital multimedia broadcasting (DMB), electronic service guide (ESG) of digital video broadcast-handheld (DVB-H), etc.

The broadcast receiving module 111 may be configured to receive broadcast signals by using various types of broadcast systems. In particular, the broadcast receiving module 111 may receive a digital broadcast signal by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 is configured to be suitable for every broadcast system that provides a broadcast signal as well as the above-mentioned digital broadcast systems.

Broadcast signals and/or broadcast-associated information received via the broadcast receiving module 111 may be stored in the memory 160 (or other type of storage medium). The mobile communication module 112 transmits and/or receives radio signals to and/or from at least one of a base station (e.g., access points, Node Bs, etc.), an external terminal (e.g., other user devices) and a server (or other network entities). Such radio signals may include a voice call signal, a video call signal or various types of data according to text and/or multimedia message transmission and/or reception.

The wireless Internet module 113 supports Internet access for the mobile terminal 100. This module may be internally or externally coupled to the mobile terminal 100. The short-range communication module 114 refers to a module for supporting short range communications. Some examples of short-range communication technology include Bluetooth™, Radio Frequency IDentification (RFID), Infrared Data Association (IrDA), Ultra-WideBand (UWB), ZigBee™, and the functional or structural equivalents.

The location information module 115 is a module for checking or acquiring a location (or position) of the mobile terminal 100. For example, the location information module 115 may be embodied by using a GPS (Global Positioning System) module that receives location information from a plurality of satellites. Here, the location information may include coordinate information represented by latitude and longitude values.

For example, the GPS module may measure an accurate time and distance from three or more satellites, and accurately calculate a current location of the mobile terminal 100 according to trigonometry based on the three different distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

The A/V input unit 120 is configured to receive an audio or video signal. The A/V input unit 120 may include a camera 121 (or other image capture device) and a microphone 122 (or other sound pick-up device). The camera 121 processes image data of still pictures or videos obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal 100. The microphone 122 may receive sounds (audible data) via a microphone (or the like) in a phone call mode, a recording mode, a voice recognition mode, and the like, and can process such sounds into audio data.

The processed audio (voice) data may be converted for output into a format transmittable to a mobile communication base station (or other network entity) via the mobile communication module 112 in case of the phone call mode. The microphone 122 may include various types of noise canceling (or suppression) algorithms to cancel (or suppress) noise or interference generated in the course of receiving and transmitting audio signals.

The user input unit 130 (or other user input device) may generate key input data from commands entered by a user to control various operations of the mobile terminal 100. The user input unit 130 allows the user to enter various types of information, and may include a keypad, a dome switch, a touch pad (e.g., a touch sensitive member that detects changes in resistance, pressure, capacitance, etc.), a jog wheel, a jog switch, or the functional or structural equivalent. In particular, when the touch pad is overlaid on the display unit 151 in a layered manner, it may be called a touch screen.

The sensing unit 140 (or other detection means) detects a current status (or state) of the mobile terminal 100 such as an opened or closed state of the mobile terminal 100, a location of the mobile terminal 100, a presence or absence of user contact (i.e. touch inputs) with the mobile terminal 100, orientation of the mobile terminal 100, an acceleration or deceleration movement and direction of the mobile terminal 100, etc., and generates commands or signals for controlling the operation of the mobile terminal 100.

For example, when the mobile terminal 100 is a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The interface unit 170 (or other connection means) serves as an interface with at least one external device connected with the mobile terminal 100. For example, the external devices may include wired or wireless headset ports, external power supply (or battery charger) ports, wired or wireless data ports, memory card ports, ports for connecting a device having an identification module, audio input/output (I/O) ports, video I/O ports, earphone ports, or the like.

Here, the identification module may be a chip (or other element with memory or storage capabilities) that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the mobile terminal 100 via a port or other connection means.

The interface unit 170 may be used to receive inputs (e.g., data, information, power, etc.) from an external device and transfer the received inputs to one or more elements within the mobile terminal 100 or may be used to transfer data from the mobile terminal 100 to an external device. The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may output information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

Meanwhile, when the display unit 151 and the touch pad are overlaid in a layered manner to form a touch screen, the display unit 151 may function as both an input device and an output device. The display unit 151 may include at least one of a Liquid Crystal Display (LCD), a Thin Film Transistor-LCD (TFT-LCD), an Organic Light Emitting Diode (OLED), a flexible display, a three-dimensional (3D) display, or the like.

The mobile terminal 100 may include two or more display units (or other display means) according to its embodiment. For example, the mobile terminal 100 may include an external display unit (that can be viewed even if the mobile terminal 100 is closed) and an internal display unit (that can be viewed if the mobile terminal 100 is opened).

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, etc.) performed by the mobile terminal 100. The audio output module 152 may include a speaker, a buzzer, or other sound generating device.

The alarm unit 153 (or other type of user notification means) may provide outputs to inform about an occurrence of an event of the mobile terminal 100. Typical events may include call reception, message reception, key or button inputs, etc. In addition to audio or video outputs, the alarm unit 153 may provide outputs in a different manner to inform about an occurrence of an event. For example, the alarm unit 153 may provide outputs in the form of vibrations or other tactile outputs, also referred to as haptic effects.

Haptics is the science of applying tactile sensation to human interaction with a device. A haptic device is one that involves physical contact between with a user, usually through an input/output device, such as a joystick, data gloves or even a touch screen, that senses the body's movements. By using haptic devices, the user can not only feed information to the device or a connected system but can receive information from the system in the form of a felt sensation on some part of the body. This is referred to as a haptic interface or haptic effect.

When a call, a message, or some other incoming communication is received, the alarm unit 153 may provide a haptic effect (here after referred to as tactile outputs or more commonly vibrations) to inform the user. By providing tactile outputs, the user can recognize the occurrence of various events even if the mobile terminal 100 is on the user's person but remains out of sight or if audio outputs would not be heard. Outputs informing about the occurrence of an event may be also provided via the display unit 151 or the audio output module 152.

The memory 160 (or other storage means) may store software programs or the like used for the processing and controlling operations performed by the controller 180, or may temporarily store data (e.g., a phonebook, messages, still images, video, etc.) that have been input or to be outputted. The memory 160 may include at least one type of storage medium including a Flash memory, a hard disk, a multimedia card, a card-type memory (e.g., SD or DX memory, etc), a Random Access Memory (RAM), a Static Random Access Memory (SRAM), a Read Memory (ROM), an Electrically Erasable Programmable Read-Only Memory (EEPROM), a Programmable Read-Only memory (PROM) magnetic memory, a magnetic disk, an optical disk, and the like. Also, the mobile terminal 100 may cooperate with a network storage device that performs the storage function of the memory 160 over a network connection.

The controller 180 (such as a microprocessor or the like) typically controls the general operations of the mobile terminal 100. For example, the controller 180 performs controlling and processing associated with voice calls, data communications, video calls, and the like. In addition, the controller 180 may include a multimedia module 181 for reproducing (or playing back) multimedia data. The multimedia module 181 may be configured within the controller 180 or may be configured to be separated from the controller 180.

The power supply unit 190 receives external power (via a power cable connection) or internal power (via the battery of the mobile terminal 100) and supplies appropriate power required for operating respective elements and components under the control of the controller 180. Various embodiments described herein may be implemented in a computer-readable medium using, for example, computer software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented in the controller 180.

For software implementation, the embodiments such as procedures or functions may be implemented together with separate software modules that allow performing of at least one function or operation. Software codes can be implemented by a software application (or program) written in any suitable programming language. The software codes may be stored in the memory 160 and executed by the controller 180.

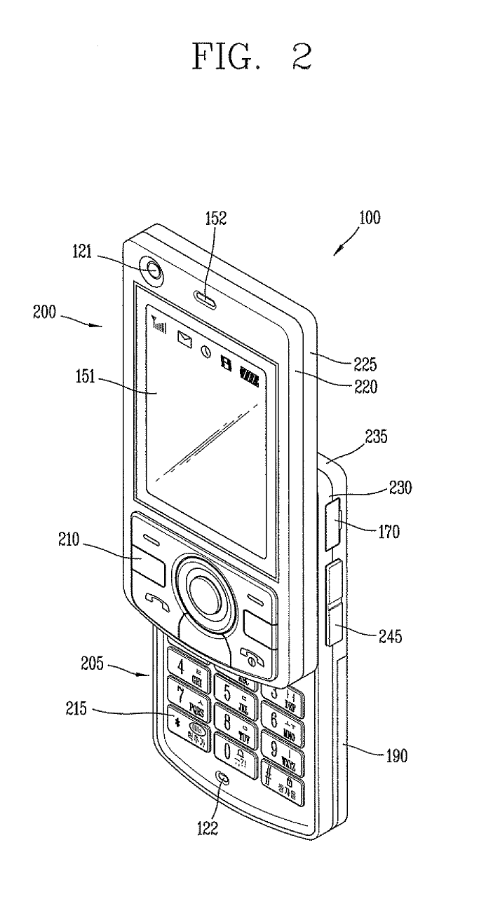

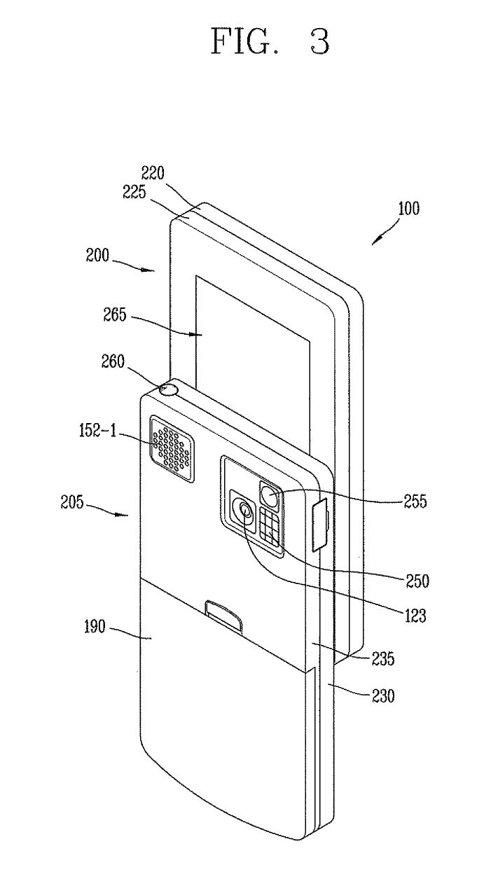

So far, the mobile terminal 100 has been described from the perspective of its functions. Hereinafter, external elements of the mobile terminal 100 will be described from the perspective of their functions with reference to FIGS. 2 and 3. Mobile terminal 100 may be implemented in a variety of different configurations. Examples of such configurations include folder-type, bar-type, swing-type, a slide type, as well as various other configurations. The following description will primarily relate to a slide-type mobile terminal 100. However, such description can equally apply to other types of terminals.

According to FIG. 2, the mobile terminal 100 may include a first body 200 and a second body 205 that can be slidably moved along at least one direction with respect to the first body 200. A state in which the first body is disposed to overlap with the second body 205 may be called a closed configuration, and as shown in FIG. 2, a state in which at least a portion of the second body 250 is exposed may be called an open configuration. In the closed configuration, the mobile terminal 100 mainly operates in a standby (or idle) mode, and the standby mode may be released upon user manipulation. The mobile terminal 100 operates mainly in the calling mode or the like in the open configuration, and it can be changed to the standby mode with the lapse of time or upon user manipulation.

At least one case (or casing, housing, cover, etc.) constituting the external appearance of the first body 200 comprises a first front case 220 and a first rear case 225. Various electronic components are installed in the space between the first front case 220 and the first rear case 225. One or more intermediate cases may be additionally disposed between the first front case 220 and the first rear case 225. The cases may be formed by injection-molding a synthetic resin or may be made of a metallic material such as stainless steel (STS) or titanium (Ti), etc.

The display unit 151, the audio output module 152, the camera 121 or the first user input unit 210 may be located at the first body, 200, specifically, on the first front case 220 of the first body 200. The display unit 151 may include an LCD (Liquid Crystal Display), an OLED (Organic Light Emitting Diode), and the like, that visually displays information. A touch pad may be overlaid in a layered manner on the display unit 151 to allow the display unit 151 to function as a touch screen to input information via user gestures or touch inputs. User touch inputs may also be achieved by so-called proximity detection techniques, whereby the user's finger or stylus may be detected when placed near the screen without actually touching the screen itself.

The audio output unit 152 may be implemented in the form of a speaker or other sound producing device. The camera 121 may be implemented to be suitable for capturing images or video with respect to the user and other objects. Like the first body 200, the case constituting the external appearance of the second body 205 may include a second front case 230 and a second rear case 235. A second user input unit 215 may be disposed at a front portion of the second body 205, specifically, on the second front case 230.

A third user input unit 245, the microphone 122, and the interface unit 170 may be disposed on at least one of the second front case 230 and the second rear case 235. The first to third user input units 210, 215 and 245 may be generally referred to as a manipulating unit 130, and various methods and techniques can be employed for the manipulating unit 130 so long as it can be operated by the user in a tactile manner. For example, the manipulating unit 130 can be implemented as dome switches, actuators, or touch pad regions that can receive user commands or information according to the user's touch operations (e.g., pressing, pushing, swiping, drag-and-drop, etc.) or may be implemented in the form of a rotatable control wheel (or disc), keys or buttons, a jog dial, a joystick, or the like.

In terms of their functions, the first user input unit 210 is used for inputting (entering) commands such as start, end, scroll or the like, and the second user input unit 215 is used for inputting (entering) numbers, characters, symbols, or the like. Also, the third user input unit 245 may support the so-called hot key functions that allow more convenient activation of particular functions for the mobile terminal 100. The microphone 122 (or other sound pick-up device) may be appropriately implemented to detect user voice inputs, other sounds, and the like.

The interface unit 170 may be used as a communication link (or passage, path, etc.) through which the mobile terminal 100 can exchange data or the like with an external device. For example, the interface unit 170 may be implemented in the form of a connection port for connecting an earphone to the mobile terminal 100 via a fixed or wireless means, a port for short-range communications (e.g., an Infrared Data Association (IrDA) port, a Bluetooth™ port, a wireless LAN port, etc.), power supply ports for providing power to the mobile terminal 100, or the like.

Also, the interface unit 170 may be a card socket for accommodating a SIM (Subscriber Identification Module) card or a UIM (User Identity Module) card, or an external card such as a memory card for storing information. The power supply unit 190 for supplying power to the mobile terminal 100 may be located at the second rear case 235. The power supply unit 190 may be, for example, a rechargeable battery that can be detached.

FIG. 3 is a rear perspective view of the mobile terminal 100 of FIG. 2 according to an exemplary embodiment. As shown in FIG. 3, a camera 121 (or other image pick-up device) may additionally be disposed on a rear surface of the second rear case 235 of the second body 205. The camera 121 of the second body 205 may have an image capture direction which is substantially opposite to that of the camera 121 of the first body 200 (namely, the two cameras may be implemented to face towards opposing directions, such as front and rear), and may support a different number of pixels (i.e., have a different resolution) than the camera 121 of the first body.

For example, the first image input unit (not shown) may operate with a relatively lower resolution to capture an image(s) of the user's face and immediately transmit such image(s) to another party in real-time during video call communication or the like in which reverse link bandwidth capabilities may be limited. Also, the second image input unit (not shown) may operate with a relatively higher resolution to capture images of general objects with high picture quality, which may not require immediately transmission in real-time, but may be stored for later viewing or use.

Additional camera related components, such as a flash 250 and a mirror 255, may be additionally disposed adjacent to the camera 121. When an image of the subject is captured with the camera 121 of the second body 205, the flash 250 illuminates the subject. The mirror 255 allows the user to see himself when he wants to capture his own image (i.e., self-image capturing) by using the camera 121 of the second body 205.

The second rear case 235 may further include an audio output module 152. The audio output module 152 may support stereophonic sound functions in conjunction with the audio output module 152 of the first body 200 and may be also used for sending and receiving calls in a speaker phone mode. A broadcast signal receiving antenna 260 may be disposed (externally or internally) at one side or region of the second rear case 235, in addition to an antenna that is used for mobile communications. The antenna 260 can also be configured to be retractable from the second body 205.

One part of a slide module 265 that allows the first body 200 and the second body 205 to slide relative to each other may be disposed on the first rear case 225 of the first body 200. The other part of the slide module 265 may be disposed on the second front case 230 of the second body 205, which may not be exposed as shown in FIG. 3. The second camera 121 and other components may be disposed on the second body 205, but such configuration is not meant to be limited.

For example, one or more of the elements which are disposed on the second rear case 235 may be mounted on the first body 200, mainly, on the first rear case 225. In this case, those elements disposed on the first rear case 225 can be protected (or covered) by the second body 205 in the closed configuration. In addition, even if a separate camera is not provided at the second body 205, the camera module 121 may be configured to rotate (or otherwise be moved) to thus allow image capturing in various directions.

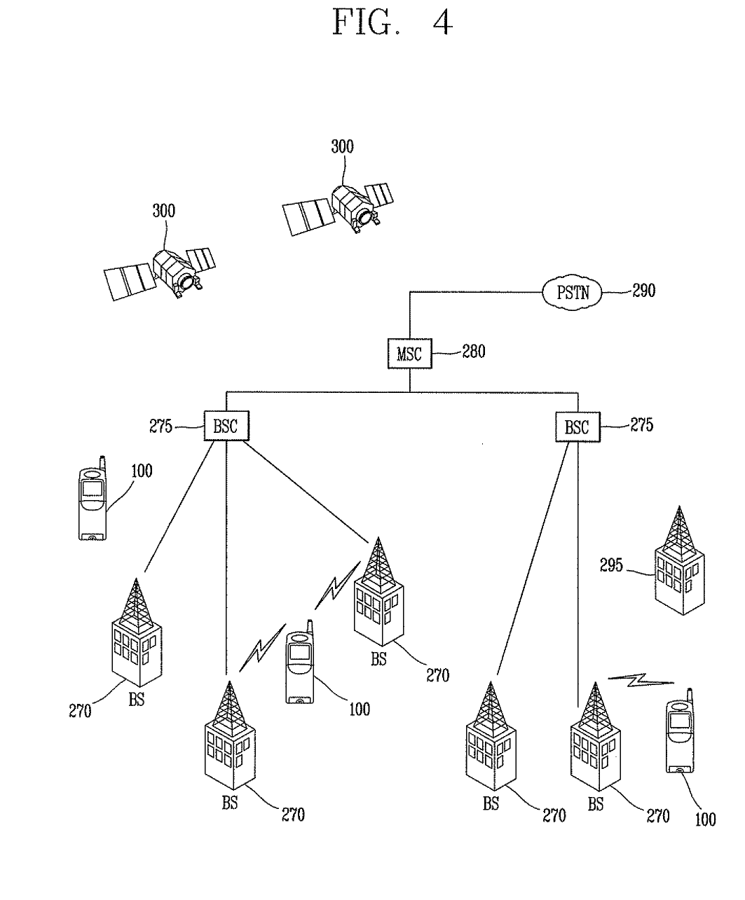

The mobile terminal 100 as shown in FIGS. 1 to 3 may be configured to operate with a communication system, which transmits data via frames or packets, such as wired and wireless communication systems, as well as satellite-based communication systems. Such communication systems in which the mobile terminal 100 according to the present disclosure can operate will now be described with reference to FIG. 4. Such communication systems may use different air interfaces and/or physical layers.

For example, air interfaces utilized by the communication systems include example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Referring to FIG. 4, a CDMA wireless communication system may include a plurality of mobile terminals 100, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system as shown in FIG. 4 may include a plurality of BSCs 275.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc).

The intersection of a sector and frequency assignment may be referred to as a CDMA channel. The BS 270 may also be referred to as base station transceiver subsystems (BTSs) or other equivalent terms. In such case, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 4, a broadcasting transmitter (BT) 295 transmits a broadcast signal to the mobile terminals 100 operating within the system. The broadcast receiving module 111 as shown in FIG. 1 is provided at the mobile terminal 100 to receive broadcast signals transmitted by the BT 295.

In FIG. 4, several global positioning system (GPS) satellites 300 are shown. The satellites 300 help locate at least one of a plurality of mobile terminals 100.

In FIG. 4, two satellites 300 are depicted, but it is understood that useful positioning information may be obtained with any number of satellites. The GPS module 115 as shown in FIG. 1 is typically configured to cooperate with the satellites 300 to obtain desired positioning information.

Instead of or in addition to GPS tracking techniques, other technologies with the ability to track the location of the mobile terminals 100 may be used. In addition, at least one of the GPS satellites 300 may selectively or additionally handle satellite DMB transmissions.

As one typical operation of the wireless communication system, the BSs 270 receive reverse-link signals from various mobile terminals 100. The mobile terminals 100 typically engaging in calls, messaging, and other types of communications. Each reverse-link signal received by a particular base station 270 is processed within the particular BS 270.

The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals 100.

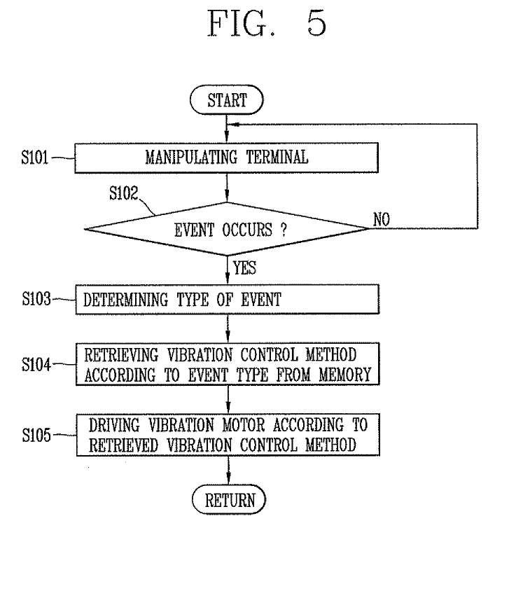

FIG. 5 is a flow chart illustrating the process of a method for controlling a vibration mechanism of the mobile terminal 100 according to the present disclosure, in which when a particular situation set through an environment setting menu occurs, driving of a vibration mechanism (not shown) is controlled according to a pre-set method.

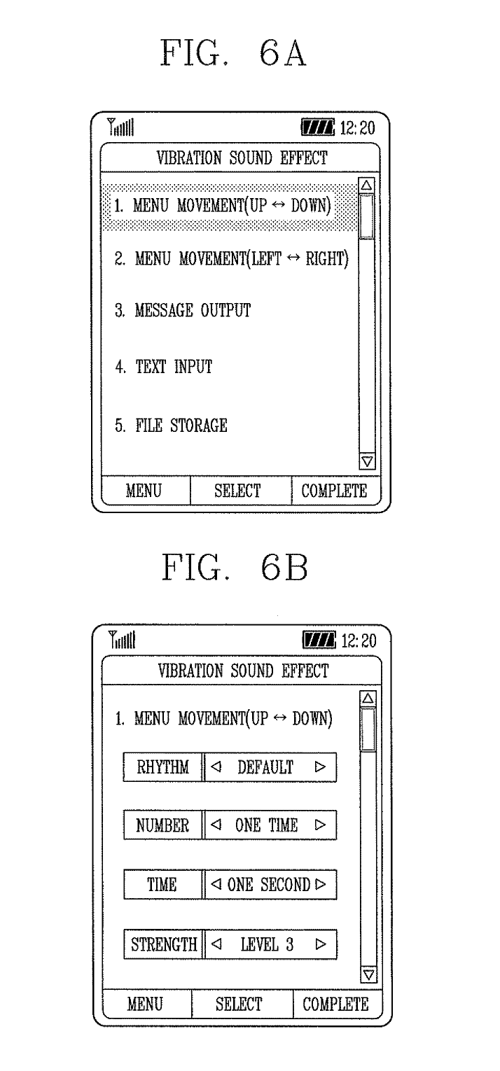

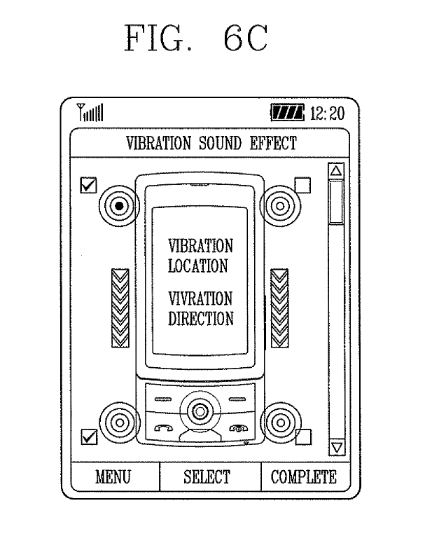

As shown in FIGS. 6A to 6C, the environment setting menu can be set for various situations for outputting vibration sound effects and vibration sound effect outputting methods. When setting of an environment through the menu is completed, the controller 180 may detect an event occurring at the set situation and drive the vibration mechanism in a pre-set manner.

The vibration mechanism may be implemented at various positions in various forms, and may be configured as means of the alarm unit 153 as described above with reference to FIG. 1. For example, when the vibration mechanism is driven, the mobile terminal 100 is entirely vibrated, and in this case, only a particular portion (e.g., a particular key, body, display unit, or the like) of the mobile terminal 100 can be concentratively vibrated according to the implemented positions and numbers of the vibration mechanisms.

Accordingly, an item for setting a vibration-concentrated location may be displayed on the environment setting menu. The preferred environment setting information may be stored at a particular region of the memory 160. With reference to FIG. 5, the controller 180 detects the type of an event occurring as the mobile terminal 100 is manipulated (S 101 to S 103).

For example, the event may include a case where shifting is made to a first menu from the last item of the menu, a case where when searching is performed, a pop-up message displaying a search result is outputted, a case where when a short message is created of when a file name is inputted, a designated length is exceeded, or a case where when a phone number is stored, the same number or name has been already stored.

Besides the above-described situations, the vibration sound effect can be outputted in various other situations. When the event has been set to generate a vibration, the controller 180 retrieves the environment setting information stored in the memory 160 (S104) and drives a vibration mechanism at a pre-set location with a pre-set strength (S105). The controller 180 can vibrate the vibration mechanism with various rhythms, strengths, and directions by controlling the strength and time for driving the vibration mechanism.

FIGS. 6A to 6C are overviews of display screens illustrating menus for setting an environment to output a vibration effect of the mobile terminal 100 according to the present disclosure, in which the design, form, order of the menu or the title of each menu item can vary according to various terminals.

The vibration effect environment setting menu may include a sub-menu for selecting various situations for outputting vibration effects as shown in FIG. 6A, a sub-menu for setting a vibration rhythm, a vibration number, a vibration length, or a vibration strength as shown in FIG. 6B, and a sub-menu for selecting a vibration location or a vibration direction.

As for the vibration direction, for example, the direction of the vibration may be controlled such that vibration of each mechanism can move up to down, down to up, left to right, right to left, interior to exterior, exterior to interior, in a diagonal direction, clockwise or counterclockwise or any other number of ways, according to a menu manipulation direction, a message output direction, or the like.

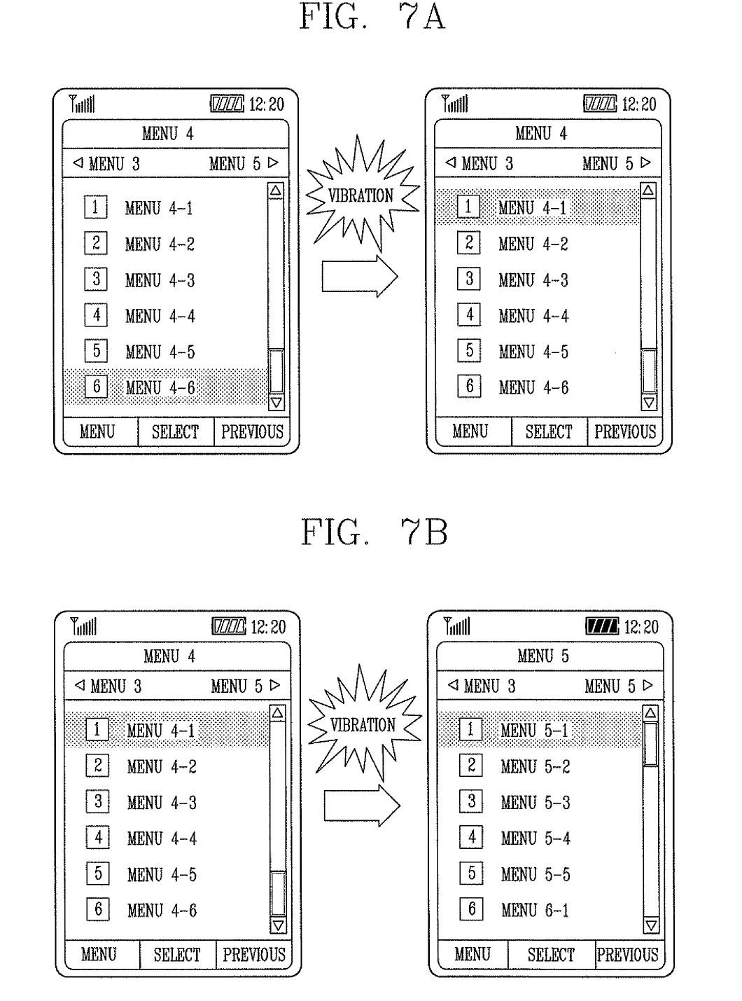

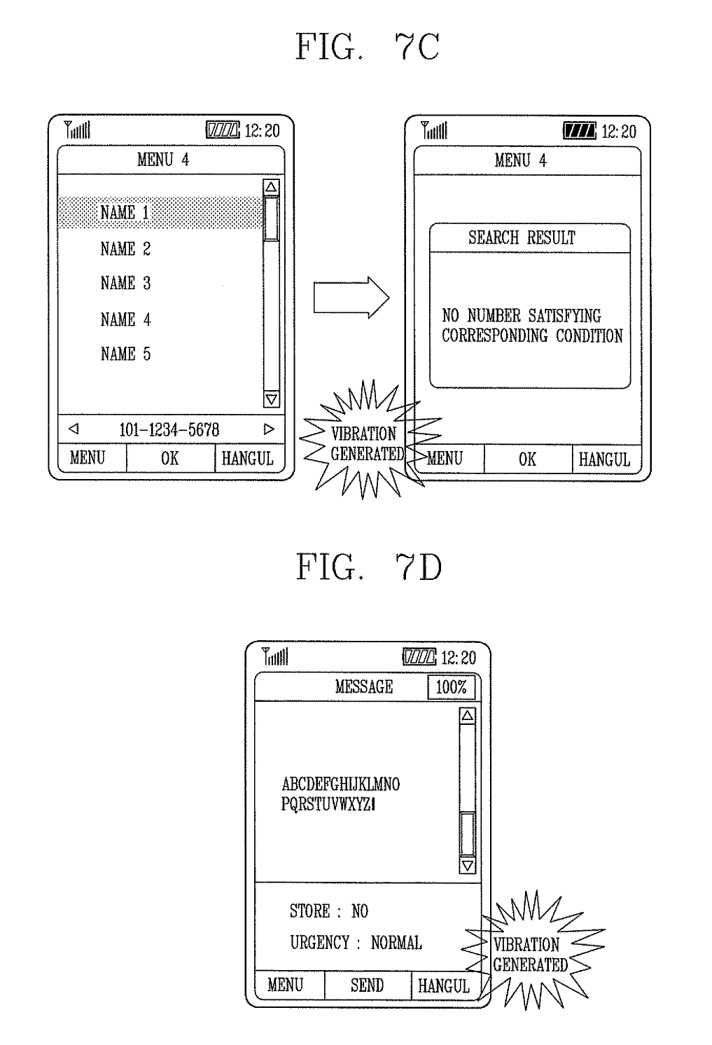

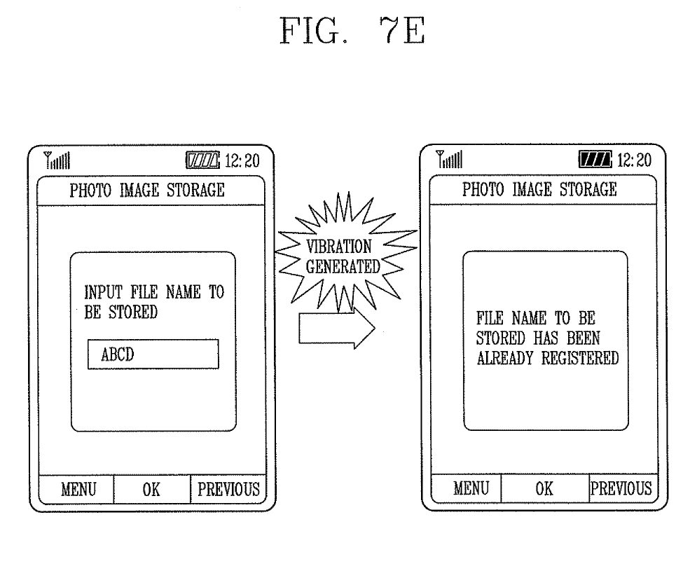

The vibration rhythm, the vibration number, the vibration length, the vibration strength, the vibration location or the vibration direction may be set as default according to types of events. FIGS. 7A to 7E are overviews of display screens illustrating a method for outputting a vibration effect for each situation that may occur in the mobile terminal 100 according to the present disclosure.

With reference to FIG. 7A, when a menu including a plurality of sub-items is scrolled up or down to move from the final item to the first item or from the first item to the last item, the controller 180 may vibrate the mobile terminal 100 according to a pre-set method. With reference to FIG. 7B, when a menu including a plurality of categories is scrolled left or right to enter a new menu category, the controller 180 may vibrate the mobile terminal 100 according to a pre-set method.

With reference to FIG. 7C, when an address or a particular menu is searched by using a search function but there is no desired search result or if a message displaying a search result is outputted, the controller 180 may vibrate the mobile terminal 100 according to a pre-set method. With reference to FIG. 7D, when a text message is created of when the name of a particular electronic file is inputted, and in this case, if the message is inputted by exceeding a limited number of letters or by exceeding a transmission-available size, the controller 180 may vibrate the mobile terminal 100 according to a pre-set method.

With reference to FIG. 7E, when a phone number or a particular electronic file is intended to be stored but the same phone number or the same name has been already stored, the controller 180 may vibrate the mobile terminal 100 according to a pre-set method. As described above, the controller 180 may generate vibration when a particular parameter value in relation to the particular events (e.g., the menu movement event, the menu category movement event, the search event, the file name exceeding event, the same file name limiting event) exceeds a pre-set certain reference value.

In this case, as for the vibration method, as described above, vibration may be concentrated to a particular location, and if two or more vibration mechanisms are provided, the mechanisms at different locations can be vibrated sequentially or randomly. In addition, the mechanisms may be alternately vibrated. In order to generate a transfer effect of vibration, the strength of one mechanism from which vibration transfer starts and that of another mechanism to which vibration is to be transferred may be adjusted to be different. For brevity, the effect of moving the vibration location will be referred to as a vibration transfer effect hereinafter.

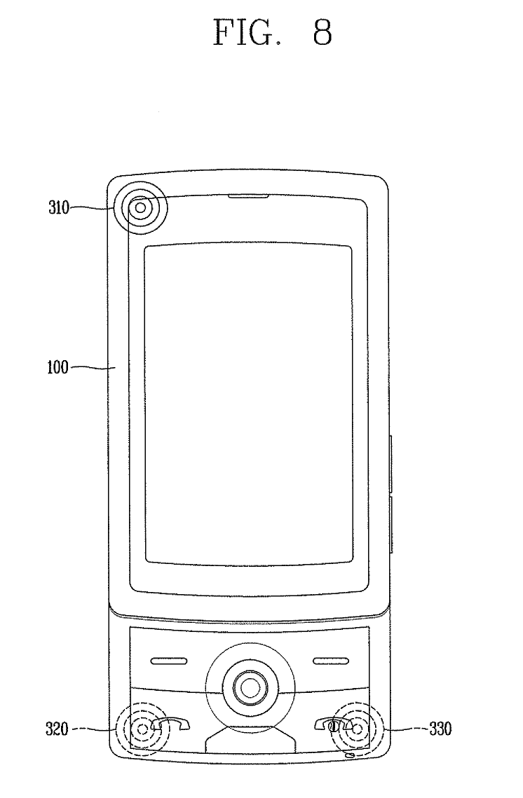

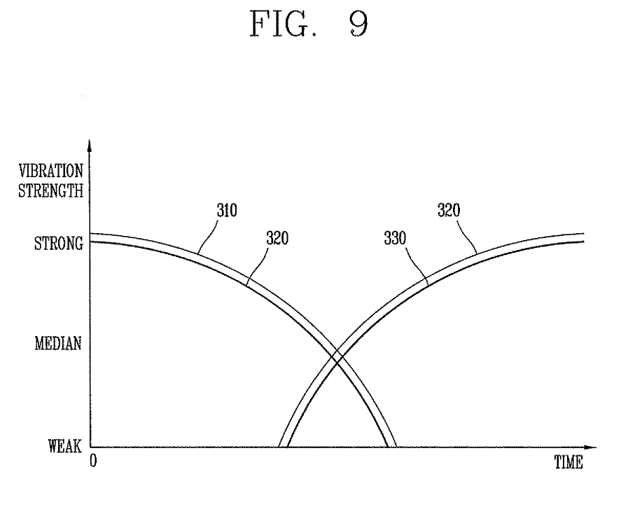

FIG. 9 is a graph for explaining a method for generating a vibration transfer effect when a vibration sound effect is outputted from the mobile terminal 100 according to the present disclosure. As shown in FIG. 8, it is assumed that the mobile terminal 100 includes three vibration mechanisms 310 to 330.

In order to obtain a vibration transfer effect from a location where the first vibration mechanism 310 is provided to a location where the second vibration mechanism 320 is provided, the controller 180 drives the first vibration mechanism 310 first with a ‘strong’ strength and then gradually drives it with a ‘weak’ strength. In addition, the controller 180 drives the second vibration mechanism 320 first with a ‘weak’ strength and then gradually drives it with a ‘strong’ strength. Accordingly, the user may feel that the vibrations are transferred.

In addition, in order to obtain a vibration transfer effect from the location where the second vibration mechanism 320 is provided to a location where the third vibration mechanism 330 is provided, the controller 180 drives the second vibration mechanism 320 first with a ‘strong’ strength and then gradually drives it with a ‘weak’ strength. In addition, the controller 180 drives the third vibration mechanism 330 first with a ‘weak’ strength and then gradually drives it with a ‘strong’ strength. Accordingly, the user may feel that the vibrations are transferred.

Namely, the controller 180 drives the vibration mechanism, from which vibration transfer starts, with the ‘strong’ strength and then gradually drives it with the ‘weak’ strength, and drives the vibration, to which the vibration is to be transferred, with the ‘weak’ strength and then gradually drives it with the ‘strong’ strength, to thereby obtaining the effect that vibrations are transferred.

The method for generating the vibration transfer effect by controlling the mechanism in the vibration direction to have the ‘strong’ and then ‘weak’ strength is merely an example, and the vibration transfer effect can be generated by any other mechanism driving methods. The effect of transferring vibrations in various other directions can be obtained by applying the above-described vibration method.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

What is claimed is:

1. A mobile terminal comprising:
a controller for detecting an event occurring when the mobile terminal is manipulated and controlling vibration of the mobile terminal according to a pre-set method based on a type of the event;
a memory for storing a vibration method in association with the type of the event; and
at least one vibration mechanism vibrating under the control of the controller,
wherein the controller generates vibration if a parameter value related to the event exceeds a certain reference value.

2. The mobile terminal of claim 1, wherein the controller controls vibration of a vibration mechanism among a plurality of vibration mechanisms at a particular location, mechanism, in association with the type of the event.

3. The mobile terminal of claim 1, wherein the controller controls vibration mechanisms at different locations, among a plurality of vibration mechanisms, to vibrate sequentially or randomly according to a pre-set method.

4. The mobile terminal of claim 1, wherein the controller controls a plurality of vibration mechanisms such that vibration starting from a first mechanism is transferred to a second mechanism.

5. The mobile terminal of claim 4, wherein the controller drives the first mechanism with a first strength level and the second mechanism with a second strength level.

6. The mobile terminal of claim 4, wherein the controller controls one or more vibration mechanisms such that vibration is transferred in at least one of the following directions up to down, down to up, left to right, right to left, interior to exterior, exterior to interior, diagonally, or clockwise and counterclockwise.

7. The mobile terminal of claim 1, wherein the controller controls one or more vibration mechanisms according to at least one of a pre-set vibration rhythm, vibration number, vibration length, vibration strength, vibration location, or vibration direction.

8. A method for controlling a vibration mechanism of a mobile terminal, the method comprising:
detecting a type of an event occurring when the terminal is manipulated,
retrieving a vibration control method according to the type of the detected event, in response to a parameter value related to the event exceeding a particular reference value,; and
driving a vibration mechanism at a particular position with a pre-set rhythm and strength according to the retrieved method.

9. The method of claim 8, wherein the event includes at least one of an event occurring when a menu including a plurality of sub-items is scrolled up and down or left and right, an event occurring when a message displaying a search result is outputted, an event occurring when a message or the name of a file is inputted by exceeding a limit, or an event occurring when a phone number or the name for storing a particular electronic file is repeated.

10. The method of claim 8, wherein, in driving the vibration mechanism, vibration mechanisms at different locations mechanism vibrate sequentially or randomly according to a pre-set method.

11. The method of claim 8, wherein in controlling one or more vibration mechanisms, the vibrations mechanisms are controlled such that vibration starting from one particular vibration mechanism is transferred to another particular vibration mechanism.

12. The method of claim 11, wherein, in driving the vibration mechanisms, the vibration mechanism from which vibration is transferred is driven at a first strength prior to the transfer and at a second strength after the transfer.

13. The method of claim 11, wherein, in driving the vibration mechanisms, the vibration mechanisms are driven such that vibration is transferred in at least one direction of up to down, down to up, left to right, right to left, interior to exterior, exterior to interior, diagonally, or clockwise and counterclockwise.

14. The method of claim 11, wherein, in driving the vibration mechanisms, the vibration mechanisms are driven according to at least one of a pre-set vibration rhythm, vibration number, vibration length, vibration strength, vibration location, or vibration direction.

15. A method implemented in a mobile communication device, the method comprising:
providing a user with one or more options to customize manner in which at least a vibration mechanism installed in the mobile communication device vibrates in response to detection of one or more events; and
customizing, in response to user input, the vibrations generated by the vibration mechanism for different events such that a differentiation between different types of events is made based on nature of different vibrations associated with each event.

16. The method of claim 15, wherein differentiation between the different vibrations is accomplished by varying vibration attributes for one or more vibration mechanisms included in the mobile communication terminal.

17. The method of claim 16 wherein the vibration attributes comprise strength, direction, length, depth, rhythm, frequency, rotation, and motion in a three-dimensional space.

18. The method of claim 17 wherein a plurality of vibration mechanisms are installed in the mobile communication terminal in a predefined configuration, such that changing the vibration attributes of adjacent vibration mechanisms simulates a transfer of motion from a first vibration mechanism to a second vibration mechanism among the plurality of vibration mechanisms.

19. The method of claim 18 wherein the simulated transfer of motion from the first vibration mechanism to the second vibration mechanism may be uniquely configured by a user to distinguish a first event from a second event.

20. The method of claim 19 wherein at least two vibration mechanisms operate to simulate a unique haptic effect, in response to detecting an event.
